(19) United States
(12) Patent Application Publication
(10) Pub. No.: US 2026/0196196 A1
(43) Pub. Date: Jul. 9, 2026

(54) MUSIC EVALUATION METHOD, APPARATUS, DEVICE, AND MEDIUM

(71) Applicant: Beijing Zitiao Network Technology Co., Ltd., Beijing (CN)

(72) Inventor: Ye MA, Beijing (CN)

(21) Appl. No.: 19/427,802

(22) Filed: Dec. 19, 2025

(30) Foreign Application Priority Data
Jan. 6, 2025 (CN) 202510016395.2

(51) Int. Cl. G10H 1/00

(52) U.S. Cl. CPC G10H 1/0025

(57) ABSTRACT

An embodiment of the present disclosure relates to a music evaluation method, apparatus, device, and medium, wherein the method includes: obtaining audio data of target music; inputting audio data of the target music into a music evaluation model to obtain a target score, wherein the music evaluation model is used to evaluate the music from a auditory dimension and determining a corresponding score; the music evaluation model is trained to determine with a music score dataset that is generated based on target interaction data of sample music.

### CROSS-REFERENCE TO RELATED APPLICATION(S

This application claims priority to Chinese Application No. 202510016395.2 filed January 06, 2025, the disclosure of which is incorporated herein by reference in its entirety.

### FIELD

The present disclosure relates to the field of computer technology, and more particularly to a music evaluation method, apparatus, device, and medium.

### BACKGROUND

The user can play music through the device, and the evaluation of music is currently implemented from the recommendation dimension or the psychoacoustic dimension.

### SUMMARY

To solve the above-described technical problems, the present disclosure provides a music evaluation method, apparatus, device, and medium.

Embodiments of the present disclosure provide a music evaluation method comprising: obtaining audio data of target music; inputting audio data of the target music into a music evaluation model to obtain a target score, wherein the music evaluation model is configured to evaluate the music from an auditory dimension and determine a corresponding score; and the music evaluation model is trained and determined with a music score dataset, and the music score dataset is generated based on target interaction data of sample music.

Embodiments of the present disclosure provide a music evaluation apparatus comprising: an obtaining module, configured to obtain audio data of target music; an evaluation module, configured to input audio data of the target music into a music evaluation model to obtain a target score, wherein the music evaluation model is configured to evaluate the music from an auditory dimension and determine a corresponding score; and the music evaluation model is trained and determined with a music score dataset, and the music score dataset is generated based on target interaction data of sample music.

Embodiments of the present disclosure further provide an electronic device, the electronic device comprising: a processor; a memory for storing the processor-executable instructions; the processor for reading the executable instructions from the memory and executing the instructions to implement a music evaluation method as provided by an embodiment of the present disclosure.

An embodiment of the present disclosure further provides a computer-readable storage medium, wherein the storage medium stores a computer program for executing the music evaluation method as provided by an embodiment of the present disclosure.

The technical solution provided by the embodiments of the present disclosure has the following advantages compared with the prior art: an embodiment of the present disclosure provide a music evaluation method, obtaining audio data of target music; inputting audio data of the target music into a music evaluation model to obtain a target score, wherein the music evaluation model is used to evaluate the music from an auditory dimension and determine a corresponding score; the music evaluation model is trained and determined with a music score dataset, the music score dataset is generated based on target interaction data of sample music.

### BRIEF DESCRIPTION OF THE DRAWINGS

The above and other features, advantages, and aspects of embodiments of the present disclosure will become more apparent with reference to the following detailed description when taken in conjunction with the accompanying drawings. Throughout the drawings, the same or similar reference numerals indicate the same or similar elements. It should be understood that the drawings are diagrammatic and that originals and elements are not necessarily drawn to scale.

FIG. 1 is a flow chart of a music evaluation method according to an embodiment of the present disclosure;

FIG. 2 is a schematic diagram of a music evaluation page according to an embodiment of the present disclosure;

FIG. 3 is a flow chart of another music evaluation method according to an embodiment of the present disclosure;

FIG. 4 is a schematic diagram of a dataset construction process according to an embodiment of the present disclosure;

FIG. 5 is a schematic diagram of a music evaluation process according to an embodiment of the present disclosure;

FIG. 6 is a schematic diagram of another music evaluation process according to an embodiment of the present disclosure;

FIG. 7 is a schematic diagram of a music evaluation apparatus according to an embodiment of the present disclosure; and

FIG. 8 is a flow chart of an electronic device according to an embodiment of the present disclosure.

### DETAILED DESCRIPTION OF EMBODIMENTS

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein; rather, these embodiments are provided for a more thorough and complete understanding of the present disclosure. It should be understood that the drawings and embodiments of the present disclosure are for illustrative purposes only, and are not intended to limit the scope of protection of the present disclosure.

It should be understood that the various steps recited in the method embodiments of the present disclosure may be performed in different orders, and/or in parallel. Furthermore, method embodiments may include additional steps and/or omit performing the steps shown. The scope of the present disclosure is not limited in this respect.

As used herein, the term “comprise” and variations thereof are open-ended terms, i.e., “including but not limited to”. The term “based on” is “based at least in part on”. The term “one embodiment” means “at least one embodiment”. The term “another embodiment” means “at least one further embodiment”. The term “some embodiments” means "at least some embodiments”. Relevant definitions of other terms will be given in the following description.

It should be noted that references to "first", "second" and the like in this disclosure are merely used to distinguish different apparatus, modules, or units, and are not used to limit the order or interdependence of functions performed by these apparatus, modules, or units.

It should be noted that references to modifications of "a" and "a plurality” in the present disclosure are illustrative and not limiting, and those skilled in the art will understand that "one or more" is to be interpreted unless the context clearly indicates otherwise.

The names of messages or information interacted between multiple apparatus in embodiments of the present disclosure are for illustrative purposes only and are not intended to limit the scope of these messages or information.

Most users do not subjectively score all the music heard by themselves, resulting in sparse data from the subjective auditory dimension of whether heard well or not, music cannot be evaluated from the subjective auditory dimension. In related technologies, the evaluation of music is implemented from the recommendation dimension analysis. For example, music recommendation can be performed by analyzing similar users or similar content through various technologies such as collaborative filtering, deep learning, and graph neural networks. One is to evaluate from the psychoacoustic dimension, for example, murmur, staccato, etc. Since most users do not subjectively score all the music heard by themselves, or since users with different cultural backgrounds, groups, etc. Having different understandings and recognitions of the same concert, resulting in sparse data from the subjective auditory dimension of whether it sounds pleasant or not, music cannot be evaluated from the subjective auditory dimension.

To solve the above-described problems, embodiments of the present disclosure provide a music evaluation method, which will be described with reference to specific embodiments.

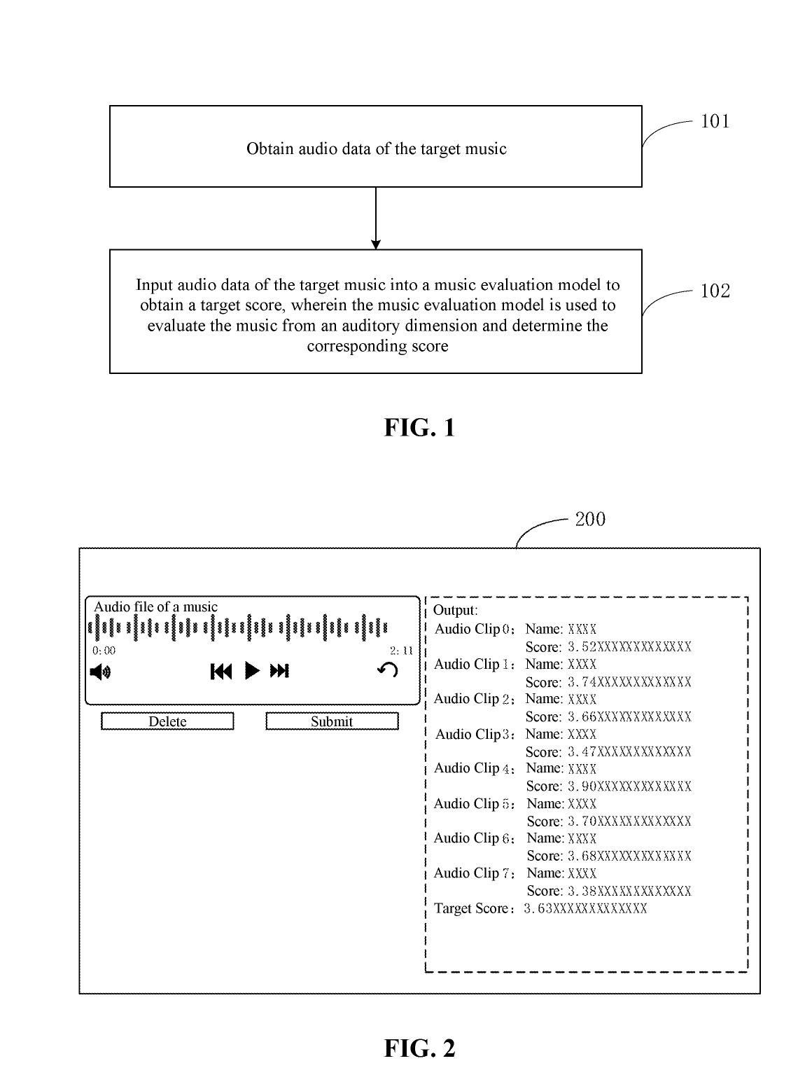

FIG. 1 is a schematic flow chart of a music evaluation method provided by an embodiment of the present disclosure, and the method may be executed by a music evaluation apparatus, wherein the apparatus may be implemented in software and/or hardware, and may be generally integrated in an electronic device. As shown in FIG. 1, the method comprises:

Step101, audio data of the target music is obtained.

The music evaluation of embodiment of the present disclosure may be understood as a score result of whether music is pleasant or listenable based on the human auditory dimension, that is, music score according to the human understanding and acceptance of music is implemented by means of the present disclosure. The target music may be any music that needs to be evaluated, and the specific amount is not limited.

In the embodiment of the present disclosure, the music evaluation apparatus may obtain audio data of the target music, for example, may obtain audio data of the music generated by the music generation model, but is not limited thereto.

Step 102, audio data of the target music is inputted into a music evaluation model to obtain a target score, wherein the music evaluation model is configured to evaluate the music from an auditory dimension and determine the corresponding score.

The music evaluation model can be a model that simulates people's evaluation of music from a subjective perspective, that is, from the auditory dimension, where the auditory dimension refers to whether it is audible or pleasant. The music evaluation model may be obtained by training based on large-scale pre-trained model, may be obtained by pre-trained on the basis of massive data, has strong content understanding capability, and has high accuracy in processing audio data. The target score may be a specific score corresponding to the target music determined inferentially by the music evaluation model.

Alternatively, the music evaluation model is trained and determined with a music score dataset, and the music score dataset is generated based on the target interaction data of sample music. The music score dataset may be a dataset for training the music evaluation model created by the embodiment of the present disclosure, the music score dataset may comprise sample music and a sample score corresponding to the sample music, the sample score may be a score determined based on target interaction data of the sample music, the sample score may be an Mean Opinion Score (MOS), the MOS is a comprehensive score obtained by statistical analysis of a set of subjective evaluation data, the target interaction data is data related to the sample music being evaluated by the user. A corresponding sample score is obtained by performing a statistical analysis on the target interaction data, for example, the sample score may range from 1 to 5, and from 1 to 5 representing, in order, the most difficult to listen to and the most pleasant to listen to.

Specifically, after the audio data of the target music is obtained, the music evaluation apparatus may input the audio data of the target music into a pre-trained music evaluation model for inferring calculation, output a target score corresponding to the target music, and present the target score to the user, and the user may perform subsequent operations according to the target score.

In some embodiments, the music evaluation model comprises a feature extraction model and a score prediction model, and inputting audio data of the target music into the music evaluation model to obtain the target score may comprise segmenting the audio data of the target music into a plurality of audio segments; inputting a plurality of audio segments into a feature extraction model to output a plurality of audio features; inputting the plurality of audio features into the score prediction model to output the target score.

The feature extraction model may be a model for extracting specific audio features of audio data of music, and optionally, the feature extraction model adopts a pre-trained model based on contrast learning as a basic model, and since the pre-trained model based on contrast learning can be trained in combination with audio and text during training, the comprehension ability is better. The score prediction model may be a model that predicts the subjective score of the audio feature, and optionally, the score prediction model adopts a regression model as a basic model, for example, the regression model may include a linear regression model, a decision tree-based regression model, etc., and is specifically determined according to the actual situations. The audio segment may be a partial segment in the audio data of the target music, and the time of the audio segment may be determined based on the requirement of the feature extraction model. For example, the audio segment may be a partial segment with a time of 10 seconds, and the audio data of the target music may be obtained by segmenting the audio data in a unit of 10 seconds.

Specifically, the music evaluation apparatus may first divide the audio data of the target music into a plurality of audio segments to meet the processing requirements of the feature extraction model in the music evaluation model. After that, the plurality of audio segments may be input into a feature extraction model for feature extraction to obtain a plurality of audio features, the plurality of audio features can be input into a score prediction model, a score corresponding to each audio feature is output, and an average value of the plurality of scores of the plurality of audio features is determined as a target score of the target audio.

Exemplarily, FIG. 2 is a schematic diagram of a music evaluation page according to an embodiment of the present disclosure. As shown in FIG. 2, the music evaluation page 200 is shown in the figure, and the music evaluation page 200 may comprise target music 201 and corresponding target scores. The target music 201 includes eight audio segments, and the target score may be an average value of a plurality of scores corresponding to the eight audio segments of the target music 201 as shown in the figure.

An embodiment of the present disclosure provide a music evaluation method, obtaining audio data of target music; inputting audio data of the target music into a music evaluation model to obtain a target score, wherein the music evaluation model is configured to evaluate the music from a auditory dimension and a corresponding score is determined; the music evaluation model is trained and determined with a music score dataset, the music score dataset is generated based on target interaction data of sample music. Adopting the above-mentioned technical solution, a music evaluation model is trained with a music score dataset generated based on target interaction data of sample music, inputting audio data of the music into a music evaluation model to obtain the score obtained from the evaluation of auditory dimension, and since the music evaluation model is trained by dataset determined by triggered interactive data of music, the music evaluation model has the data understanding ability and the music evaluation ability from a auditory dimension of whether it sounds pleasant or not, and can evaluate music from the subjective auditory dimension.

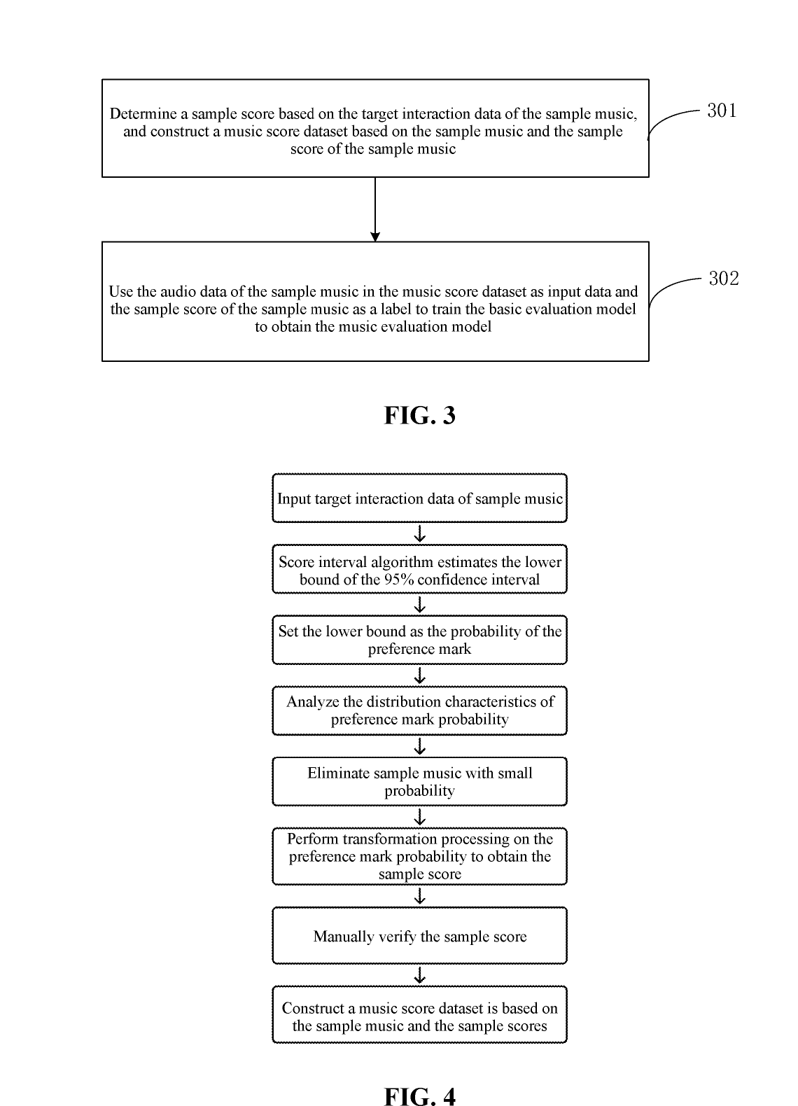

By way of example, FIG. 3 is a flow chart of another music evaluation method according to an embodiment of the present disclosure. As shown in FIG. 3, in one possible embodiment, a music evaluation model is determined as follows:

Step 301, a sample score is determined based on the target interaction data of the sample music, and a music score dataset is constructed based on the sample music and the sample score of the sample music.

The sample music may be music used to train a music evaluation model. The sample music may be a music dataset that has obtained permission from the copyright holder, which is determined based on actual circumstances. The sample score may be a score determined based on the target interaction data of the sample music. The sample score may be an average opinion score. The target interaction data is data related to the evaluation of the sample music by users. The corresponding sample score is obtained by statistically analyzing the target interaction data. For example, the sample score may range from 1 to 5, from 1 to 5, representing from the most difficult to listen to the most pleasant to listen. The music score dataset may be a dataset created by the embodiment of the present disclosure for training a music evaluation model. The music score dataset may include sample music and sample scores corresponding to the sample music. There are a plurality of sample music, which can be a large number.

In some embodiments, determining the sample score based on the target interaction data of the sample music may include: determining a corresponding preference mark probability based on the target interaction data of each sample music; deleting sample music among the plurality of sample music whose preference mark probability is lower than a probability threshold; linear transformation and discrete mapping are performed on the preference mark probabilities of the deleted multiple sample music to obtain a sample score corresponding to each sample music.

The preference mark probability represents a probability that a sample music is subjected to a preference mark operation, and the embodiment of the present disclosure may determine the preference mark probability by performing distribution ratio estimation based on the target interaction data, and the value of the preference mark probability is from 0-1; the preference mark operation may be an operation in which a music is liked or focused by a user, and the preference mark operation in the embodiment of the present disclosure may include at least one of favoriting, liking, and sharing, etc. The probability threshold may be the maximum value set for the preference mark probability, and may be specifically set according to the actual situations.

Specifically, when determining the sample score of each sample music, the music evaluation apparatus may first determine the corresponding preference mark probability by calculating the distribution ratio estimation based on the target interaction data of the sample music, and the preference mark probability may reflect the subjective score level of the sample music. After that, the preference mark probability of each sample music may be compared with the probability threshold, and the sample music whose preference mark probability is lower than the probability threshold can be deleted. Then, with regard to the preference mark probability of each sample music after deletion, a transformation processing may be performed, and the transformation processing is used for mapping the preference mark probability to a pre-set score range, wherein the pre-set score range may be from 1-5. For example, a transformation process may include a linear transformation and a discrete mapping, wherein the linear transformation can be a logarithmic function, for example, the discrete mapping may be a result of the linear transformation being mapped to the pre-set score range by multiplying, adding, subtracting, etc., and the coefficients may be set according to the actual situations. The score of the preference mark probability transformation processing of each sample music may be then determined as a corresponding sample score, and then the sample score of a plurality of sample music may be determined ,and the sample scores serve as labels to construct a music score dataset.

Optionally, the target interaction data includes a playback amount and a preference mark amount, and a corresponding preference mark probability is determined based on the target interaction data of each sample music may comprise: a ratio of the preference mark amount to the playback amount of each sample music is determined as a sample passing ratio when in estimating binomial distribution ratio; a score interval algorithm is used to determine a lower bound value of a confidence interval of a corresponding binomial distribution ratio based on a preference mark amount, a playback amount and a sample passing ratio of each of the sample music and a pre-set confidence level, and the lower bound value of the confidence interval is determined as a preference mark probability of each sample music.

The playback amount may be a specific number of times a piece of music is played, the preference mark amount may be a number of times a piece of music is subjected to a preference mark operation, and the preference mark operation may include at least one of favoriting, liking, sharing, and the like. The binomial distribution ratio estimation is a method of estimating success probability (that is, ratio parameter) by binomial distribution, in which there are only two possible results (success or failure) in each trial, and the success probability remains unchanged in each trial, and each trial is independent of the other. When the embodiment of the present disclosure performs binomial distribution ratio estimation using a playback amount and a preference mark amount for each sample music, the probability of each play being subjected to a preference mark operation is estimated, that is, the corresponding preference mark probability is determined. The score interval algorithm is an algorithm capable of estimating the confidence interval of the binomial distribution ratio, and the embodiment of the present disclosure calculates a lower bound value of the confidence interval, because the larger the lower limit value, the higher the probability of preference mark generally indicating the sample music, that is, the higher the popularity of the sample music, and the score interval algorithm can be specifically set according to the actual situations. For example, the score interval algorithm may include a normal approximation method, a quality ranking method, and the like. The confidence interval is an interval range for estimating the population parameter, and the population parameter of the embodiment of the present disclosure refers to the preference mark probability of sample music, which includes an upper limit value and a lower limit value. At a given confidence level, the real value of the population parameter has a certain probability of falling within this interval. The confidence level is a measure of the reliability of the confidence interval, which indicates how many ratios of the confidence interval will contain the real value of the population parameter if multiple samples are performed and the confidence interval is calculated. In the embodiment of the present disclosure, the confidence level is 95% as an example, which indicates that there is 95% confidence that the real value of the population parameter is within the calculated confidence interval.

Specifically, when the music evaluation apparatus determines the corresponding preference mark probability for each sample music, the binomial distribution ratio estimation may be performed using a playback amount and a preference mark amount, at this time, the preference mark amount can be considered to be a random sample in the playback amount, the probability of each playback being preference marked is fixed, the preference mark amount is regarded as a successful event, the playback amount is regarded as a total number of trials, and the ratio of the preference mark amount to the playback amount is determined as a sample passing ratio. After that, the preference mark amount, the playback amount, the sample passing ratio and the preset confidence level of the sample music may be input into the formula of the score interval algorithm, and the lower bound value of the confidence interval of the binomial distribution ratio can be calculated, and the lower bound value is determined as the preference mark probability of the sample music, that is, the lower bound value represents the lowest possible value of the preference mark probability under the preset confidence level.

By way of example, assuming that the preference mark amount of one sample music is 2, the playback amount is 10, the calculated preference mark probability is 0.0547, the preference mark amount of the other sample music is 2000, the playback amount is 10000, and the calculated preference mark probability is 0.1956. Although the sample passing ratio of the two sample music are both 20%, the preference mark probability are different due to the difference in playback amount, and the sample pass ratio has a lower reliability under a small sample size. In the case of a large sample size, the sample pass ratio has a higher reliability, and therefore the score interval algorithm in the embodiment of the present disclosure can adopt an algorithm which is more applicable to the posterior probability estimation correlation of a small sample, a more conservative estimation of the sample pass ratio will be given to reflect its uncertainty. When the sample size is large, the estimate it gives will be closer to the sample pass ratio, so that the sample pass ratio of different sample music may be compared more reliably, especially in the case of large the sample size difference.

In the above-mentioned scheme, a statistical analysis is performed on the sample music to map to a relatively confidence degree, and since the larger the sample size, the higher confidence degree, by selecting an algorithm related to posterior probability estimation, a score of the music with the maximum confidence degree may be estimated according to the preference mark amount of the playback amount in the interactive data, and a corresponding music score dataset with higher robustness can be constructed for subsequent model training.

Step 302, the audio data of the sample music in the music score dataset is used as input data, and the sample score of the sample music is used as a label to train the basic evaluation model to obtain the music evaluation model.

The basic evaluation model may be a model that has not been trained yet, and the basic evaluation model may include a pre-trained model based on contrastive learning and a regression model.

Specifically, after constructing the music score dataset, the music evaluation apparatus may using the audio data of the sample music as input data and the sample score of the sample music as labels, and train the pre-trained model based on contrast learning and the regression model in the basic evaluation model, and in specific training, the audio data of the sample music may be divided into a plurality of audio segments, input into the pre-trained model based on contrast learning, and output a plurality of sample audio features. A plurality of sample audio features are input into the regression model, and the output results are calculated for loss with the sample score as the label to reach the convergence condition, so that the basic evaluation model at this time may be determined as the music evaluation model.

Exemplarily, FIG. 4 is a schematic diagram of a data set construction process provided by an embodiment of the present disclosure. As shown in FIG. 4, the figure shows the construction process of a music rating data set, which may specifically include: input of target interactive data of sample music; estimation of the lower limit value of the 95% confidence interval by the rating interval algorithm; determination of the lower limit value as the probability of preference marking; analysis of the distribution characteristics of the probability of preference marking; elimination of sample music with small probability; transformation processing of the probability of preference marking to obtain sample scores; manual verification of the sample scores; and construction of a music rating data set based on the sample music and the sample scores.

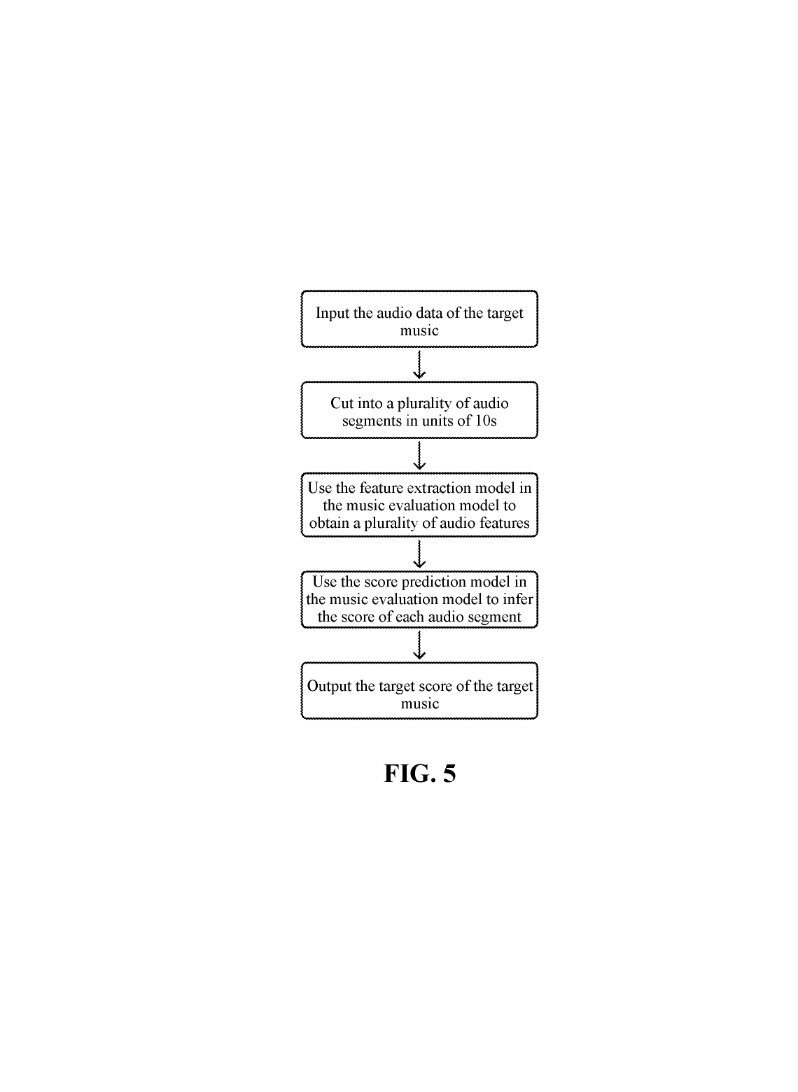

By way of example, FIG. 5 is a schematic diagram of a music evaluation process provided by an embodiment of the present disclosure. As shown in FIG. 5, which illustrates the music evaluation process, specifically comprising: inputting audio data of target music; cutting into a plurality of audio segments in units of 10s; using the feature extraction model in the music evaluation model to obtain a plurality of audio features; using the score prediction model in the music evaluation model to infer the score of each audio segment; outputting the target score of the target music.

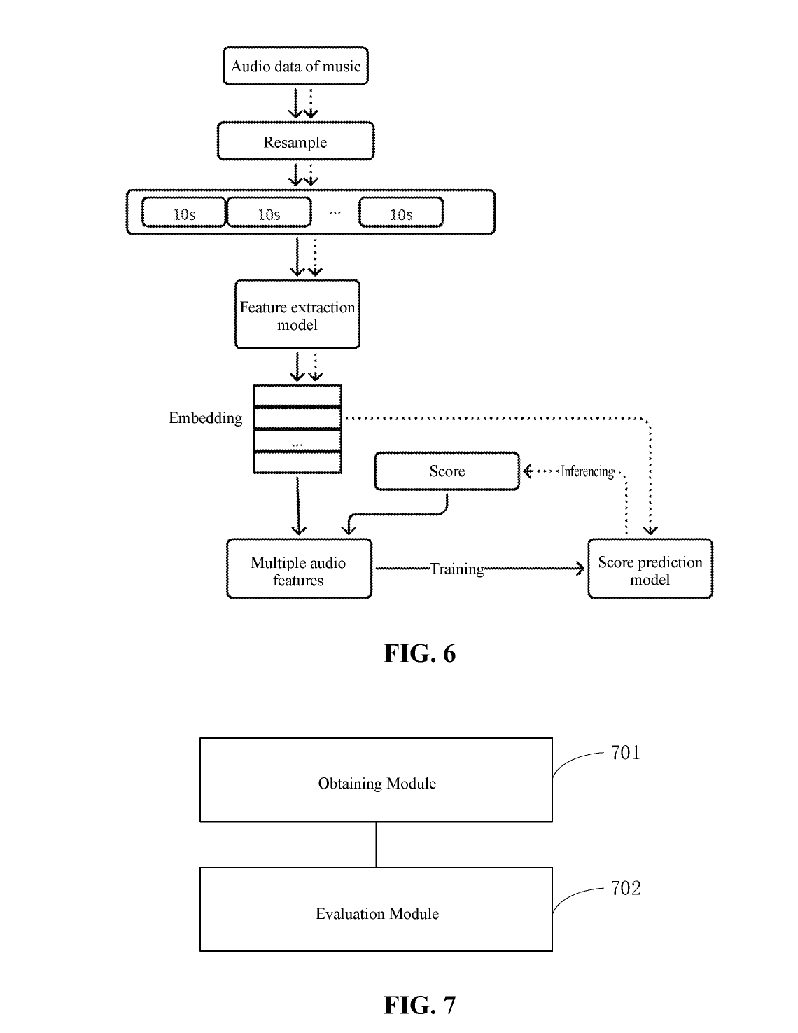

By way of example, FIG. 6 is a schematic diagram of another music evaluation process provided by the embodiment of the present disclosure. As shown in FIG. 6, the training process of the music evaluation model (solid arrow in the figure) and an inference process of audio data of the target music (dotted arrow in the figure) in the embodiment of the present disclosure are shown. For the training process of the music evaluation model, the audio data of the music refers to the audio data of the sample music, and the score refers to the sample score as a label, while for the inference process of the audio data of the target music, the audio data of the music refers to the audio data of the target music. Score refers to the target score of the final inference output.

In this scheme, a sample score is determined based on the target interaction data of the sample music, and a music score dataset is constructed based on the sample music and the sample score of the sample music; the audio data of the sample music is used as the input data and the sample score of sample music is used as the label. The basic evaluation model is trained to obtain the music evaluation model, the music evaluation dataset is constructed by the interactive data of the music representation preference and the music evaluation model is trained, so that the music evaluation model dataset has the ability of subjective score from the auditory dimension, and the music evaluation implements higher accuracy.

FIG. 7 is a structural schematic diagram of a music evaluation apparatus according to an embodiment of the present disclosure, which may be implemented in software and/or hardware, and which may be generally integrated in an electronic device. As shown in FIG. 7, the apparatus comprises: an obtaining module 701, configured to obtain audio data of target music; an evaluation module 702, configured to inputting audio data of the target music into a music evaluation model to obtain a target score, wherein the music evaluation model is used to evaluate the music from an auditory dimension and determine a corresponding score; the music evaluation model is trained and determined with a music score dataset, and the music score dataset is generated based on target interaction data of sample music.

Optionally, the music evaluation model comprises a feature extraction model and a score prediction model, and the evaluation module 702 is used for: segmenting audio data of the target music into a plurality of audio segments; inputting the plurality of audio segments into the feature extraction model to output a plurality of audio features; inputting the plurality of audio features into the score prediction model to output the target score.

Optionally, the feature extraction model adopts a pre-trained model based on comparative learning as a basic model, and the score prediction model adopts a regression model as a basic model.

Optionally, the apparatus further includes a model training module, the model training module includes: a construction unit for determining a sample score based on the target interaction data of the sample music, and constructing a music score dataset based on the sample music and the sample score of the sample music; a training unit for training a basic evaluation model to obtain the music evaluation model by using the audio data of the sample music in the music score dataset as input data and the sample score of the sample music as a label.

Optionally, there are a plurality of sample music, and the construction unit is used for: determining a corresponding preference mark probability based on target interaction data for each sample music; deleting sample music with a preference mark probability lower than a probability threshold from a plurality of sample music; performing linear transformation and discrete mapping on the preference mark probabilities of the deleted plurality of sample music pieces to obtain a sample score corresponding to each sample music.

Optionally, the target interaction data includes a playback amount and a preference mark amount, the construction unit is used for: determining a ratio of the preference mark amount to the playback amount of each of the sample music as a sample passing ratio when a binomial distribution ratio is estimated; a score interval algorithm is used to determine a lower bound value of a confidence interval of a corresponding binomial distribution ratio based on a preference mark amount, a play amount and a sample passing ratio of each sample music and a pre-set confidence level, and the lower bound value of confidence interval is determined as a preference mark probability of each sample music.

Optionally, the preference mark probability represents a probability that the sample music is subjected to a preference marking operation, the preference mark operation includes at least one of favoriting, liking, and sharing.

The music evaluation apparatus according to the embodiment of the present disclosure may perform the music evaluation method according to any embodiment of the present disclosure, and has functional modules and advantageous effects corresponding to the execution method.

Embodiments of the present disclosure also provide a computer program product comprising a computer program/instruction that, when executed by a processor, implements the music evaluation method provided by any embodiment of the present disclosure.

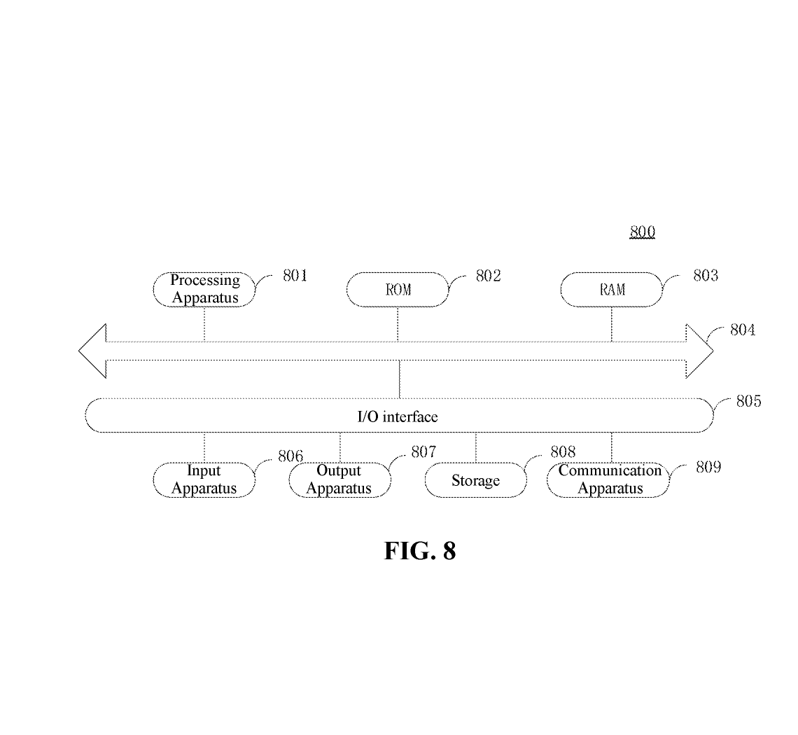

FIG. 8 is a structural schematic diagram of an electronic device provided by an embodiment of the present disclosure. Specific reference is made below to FIG. 8, which shows a schematic structural diagram suitable for implementing an electronic device 800 in an embodiment of the present disclosure. The electronic device 800 in the embodiment of the present disclosure may include, but is not limited to, a mobile terminal such as a mobile phone, a notebook computer, a digital broadcast receiver, a PDA (Personal Digital Assistant), a PAD (Tablet Computer), a PMP (Portable Multimedia Player), an in-vehicle terminal (for example, an in-vehicle navigation terminal), and the like, and a fixed terminal such as a digital TV, a desktop computer, and the like. The electronic device illustrated in FIG. 8 is merely an example, and should not pose any limitation on the scope of use or functionality of embodiments of the present disclosure.

As shown in FIG. 8, the electronic device 800 may include a processing apparatus (such as a central processing unit, a graphics processor, or the like) 801 that may perform various suitable actions and processes according to a program stored in a read-only memory (ROM) 802 or a program loaded from a storage 808 into a random access memory (RAM) 803. In the RAM 803, various programs and data necessary for the operation of the electronic device 800 are also stored. The processing device 801, the ROM 802, and the RAM 803 are connected to each other by a bus 804. An input/output (I/O) interface 805 is also connected to the bus 804.

Generally, the following devices may be connected to the I/O interface 805: an input apparatus 806 including, for example, a touch screen, a touch pad, a keyboard, a mouse, a camera, a microphone, an accelerometer, a gyroscope, and the like, an output apparatus 807 including, for example, a liquid crystal display (LCD), a speaker, a vibrator, or the like, a storage 808 including, for example, a magnetic tape, a hard disk, or the like, and a communication apparatus 809. The communication apparatus 809 may allow the electronic device 800 to communicate wirelessly or wired with other devices to exchange data. Although FIG. 8 illustrates an electronic device 800 with various apparatus, it should be understood that it is not required that all of the apparatus shown be implemented or provided. More or fewer apparatus may alternatively be implemented or provided.

In particular, according to embodiments of the present disclosure, the processes described above with reference to the flow charts may be implemented as computer software programs. For example, embodiments of the present disclosure include a computer program product comprising a computer program embodied on a non-transitory computer-readable medium, the computer program including program code for performing the method shown in the flow charts. In such embodiments, the computer program may be downloaded and installed from the network via the communication apparatus 809, or installed from the storage 808, or installed from the ROM 802. When the computer program is executed by the processing apparatus 801, the above-described functions defined in the music evaluation method of the embodiment of the present disclosure are performed.

Note that the computer-readable medium described above in this disclosure can be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus, or device, or a combination of any of the above. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that containing or storing a program that may be used by or in connection with an instruction execution system, apparatus, or device. Whereas in the present disclosure, a computer-readable signal medium may comprise a data signal embodied in baseband or as part of a carrier wave, carrying computer-readable program code therein. Such propagated data signals may take many forms, including, but not limited to, electromagnetic signals, optical signals, or any suitable combination of the preceding. The computer-readable signal medium may also be any computer-readable medium other than a computer-readable storage medium that may transmit, propagate, or transport a program for use by or in connection with an instruction execution system, apparatus, or device. The program code contained on the computer-readable medium may be transmitted using any suitable medium, including, but not limited to, wires, optical cables, RF (radio frequency), or the like, or any suitable combination of the above.

In some embodiments, the client, server may communicate using any currently known or future developed network protocol such as HTTP (HyperText Transfer Protocol), and may be interconnected with any form or medium of digital data communication (e.g., a communication network). Examples of communication networks include local area networks ("LAN"), wide area networks ("WAN"), the Internet (e.g., the Internet), and peer-to-peer networks (e.g., ad hoc peer-to-peer networks), as well as any currently known or future-developed networks.

The computer-readable medium may be included in the electronic device; it may also be separate and not fitted into the electronic device.

The above-mentioned computer readable medium carries one or more programs, and when the above-mentioned one or more programs are executed by the electronic device, the electronic device is caused to: obtain audio data of target music; input audio data of the target music into a music evaluation model to obtain a target score, wherein the music evaluation model is used for evaluating music from a auditory dimension and determining a corresponding score; the music evaluation model is trained and determined with a music score dataset that is generated based on target interaction data for sample music.

Computer program code for carrying out the operations of the present disclosure may be written in one or more programming languages, or combinations thereof, including, but not limited to, object-oriented programming languages such as Java, Smalltalk, C + +, but also conventional procedural programming languages such as the "C" language or similar programming languages. The program code may be executed entirely on the user's computer, partially on the user's computer, as a standalone software package, partially on the user's computer and partially on a remote computer, or entirely on a remote computer or server. In cases involving a remote computer, the remote computer may be connected to the user computer through any type of network, including a local area network (LAN) or a wide area network (WAN), or may be connected to an external computer (e.g., through the Internet using an Internet Service Provider).

The flow charts and block diagrams in the drawings illustrate the architecture, functionality, and operation of possible implementations of systems, methods, and computer program products in accordance with various embodiments of the present disclosure. In this regard, each block in the flow chart or block diagram may represent a module, program segment, or portion of code that contains one or more executable instructions for implementing a specified logical function(s). It should also be noted that, in some alternative implementations, the functions noted in the blocks may also occur out of the order noted in the figures. For example, two blocks shown in succession may actually be executed substantially in parallel, or the blocks may sometimes be executed in reverse order, depending upon the functionality involved. It is also noted that each block in the block diagrams and/or flowchart diagrams, and combinations of blocks in the block diagrams and/or flow charts illustrations, may be implemented by special-purpose hardware-based systems which perform the specified functions or operations, or combinations of special-purpose hardware and computer instructions.

The units described in the embodiments of the present disclosure may be implemented by software or hardware. Here, the name of the unit does not constitute a limitation of the unit itself in some cases.

The functions described above herein may be performed, at least in part, by one or more hardware logic components. For example, and without limitation, exemplary types of hardware logic components that may be used include: a field programmable gate array (FPGA), an application specific integrated circuit (ASIC), an application specific standard product (ASSP), a system-on-chip (SOC), a complex programmable logic device (CPLD), and the like.

In the context of the present disclosure, a machine-readable medium may be a tangible medium that may contain or store a program for use by or in connection with an instruction execution system, apparatus, or device. The machine readable medium may be a machine readable signal medium or a machine readable storage medium. The machine-readable medium may include, but is not limited to, an electronic, magnetic, optical, electromagnetic, infrared, or semiconductor system, apparatus, or device, or any suitable combination of the preceding. More specific examples of a machine-readable storage medium would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the preceding.

It is understood that before using the technical solution disclosed in each embodiment of the present disclosure, the type of information, scope of use, use scenarios, etc. Referred to in the present disclosure should be informed to the user and authorized by the user in an appropriate manner in accordance with relevant laws and regulations.

The above description is merely an explanation of preferred embodiments of the present disclosure and the technical principles employed. It will be understood by those skilled in the art that the scope of the present disclosure is not limited to the particular combination of features described above, but is intended to cover other combinations of features described above or their equivalents without departing from the spirit of the disclosure. For example, the above-mentioned features and the technical features disclosed in the present disclosure (but not limited to) having similar functions are interchanged to form a technical solution.

Furthermore, while operations are depicted in a particular order, this should not be understood as requiring the operations to be performed in the particular order shown or in a sequential order. Under certain circumstances, multitasking and parallel processing may be advantageous. As such, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. Rather, the specific features and acts described above are merely exemplary forms for implementing the claims.

We claim:

1. A music evaluation method, comprising:
obtaining audio data of target music;
inputting audio data of the target music into a music evaluation model to obtain a target score, wherein the music evaluation model is configured to evaluate the music from an auditory dimension and determine a corresponding score; and
the music evaluation model is trained and determined with a music score dataset, and the music score dataset is generated based on target interaction data of sample music.

2. The method of claim 1, wherein the music evaluation model comprises a feature extraction model and a score prediction model, and inputting audio data of the target music into the music evaluation model to obtain the target score comprises:
segmenting audio data of the target music into a plurality of audio segments;
inputting the plurality of audio segments into the feature extraction model to output a plurality of audio features; and
inputting the plurality of audio features into the score prediction model to output the target score.

3. The method of claim 2, wherein the feature extraction model adopts a pre-trained model based on comparative learning as a basic model, and the score prediction model adopts a regression model as a basic model.

4. The method of claim 1, wherein the music evaluation model is determined by:
determining a sample score based on the target interaction data of the sample music, and constructing a music score dataset based on the sample music and the sample score of the sample music; and
using the audio data of the sample music in the music score dataset as input data and the sample score of the sample music as a label to train the basic evaluation model to obtain the music evaluation model.

5. The method of claim 4, wherein there are a plurality of sample music, and determining a sample score based on target interaction data of the sample music comprises:
determining a corresponding preference mark probability based on target interaction data of each sample music;
deleting sample music with a preference mark probability lower than a probability threshold from the plurality of sample music; and
performing linear transformation and discrete mapping on the preference mark probabilities of the deleted plurality of sample music to obtain a sample score corresponding to each sample music.

6. The method of claim 5, wherein the target interaction data comprises a playback amount and a preference mark amount, and determining the corresponding preference mark probability based on the target interaction data of each sample music comprises:
determining a ratio of the preference mark amount to the playback amount of each sample music as a sample passing ratio in estimating a binomial distribution ratio; and
using a score interval algorithm to determine a lower bound value of a confidence interval of a corresponding binomial distribution ratio based on a preference mark amount, a playback amount and a sample passing ratio of each sample music and a pre-set confidence level, and determining the lower bound value of the confidence interval as a preference mark probability of each sample music.

7. The method of claim 5, wherein the preference marking probability represents a probability that the sample music is subjected to a preference marking operation, and the preference marking operation comprises at least one of favoriting, liking, and sharing.

8. An electronic device comprising:
a processor;
a memory for storing the processor-executable instructions, when executed by the processor, causing the device to:
obtain audio data of target music;
input audio data of the target music into a music evaluation model to obtain a target score, wherein the music evaluation model is configured to evaluate the music from an auditory dimension and determine a corresponding score; and
the music evaluation model is trained and determined with a music score dataset, and the music score dataset is generated based on target interaction data of sample music.

9. The device of claim 8, wherein the music evaluation model comprises a feature extraction model and a score prediction model, and instructions causing the device to input audio data of the target music into the music evaluation model to obtain the target score comprise instructions causing the device to:
segment audio data of the target music into a plurality of audio segments;
input the plurality of audio segments into the feature extraction model to output a plurality of audio features; and
input the plurality of audio features into the score prediction model to output the target score.

10. The device of claim 9, wherein the feature extraction model adopts a pre-trained model based on comparative learning as a basic model, and the score prediction model adopts a regression model as a basic model.

11. The device of claim 8, wherein instructions causing the device to determine the music evaluation model comprise instructions causing the device to:
determine a sample score based on the target interaction data of the sample music, and construct a music score dataset based on the sample music and the sample score of the sample music; and
use the audio data of the sample music in the music score dataset as input data and the sample score of the sample music as a label to train the basic evaluation model to obtain the music evaluation model.

12. The device of claim 11, wherein there are a plurality of sample music, and instructions causing the device to determine a sample score based on target interaction data of the sample music comprise instructions causing the device to:
determine a corresponding preference mark probability based on target interaction data of each sample music;
delete sample music with a preference mark probability lower than a probability threshold from the plurality of sample music; and
perform linear transformation and discrete mapping on the preference mark probabilities of the deleted plurality of sample music to obtain a sample score corresponding to each sample music.

13. The device of claim 12, wherein the target interaction data comprises a playback amount and a preference mark amount, and instructions causing the device to determine the corresponding preference mark probability based on the target interaction data of each sample music comprise instructions causing the device to:
determine a ratio of the preference mark amount to the playback amount of each sample music as a sample passing ratio in estimating a binomial distribution ratio;
use a score interval algorithm to determine a lower bound value of a confidence interval of a corresponding binomial distribution ratio based on a preference mark amount, a playback amount and a sample passing ratio of each sample music and a pre-set confidence level, and determine the lower bound value of the confidence interval as a preference mark probability of each sample music.

14. The device of claim 12, wherein the preference marking probability represents a probability that the sample music is subjected to a preference marking operation, and the preference marking operation comprises at least one of favoriting, liking, and sharing.

15. A non-transitory computer-readable storage medium, wherein the storage medium storing the processor-executable instructions, when executed by a processor, causing an electronic device to:
obtain audio data of target music;
input audio data of the target music into a music evaluation model to obtain a target score, wherein the music evaluation model is configured to evaluate the music from an auditory dimension and determine a corresponding score; and
the music evaluation model is trained and determined with a music score dataset, and the music score dataset is generated based on target interaction data of sample music.

16. The medium of claim 15, wherein the music evaluation model comprises a feature extraction model and a score prediction model, and instructions causing the device to input audio data of the target music into the music evaluation model to obtain the target score comprise instructions causing the device to:
segment audio data of the target music into a plurality of audio segments;
input the plurality of audio segments into the feature extraction model to output a plurality of audio features; and
input the plurality of audio features into the score prediction model to output the target score.

17. The medium of claim 16, wherein the feature extraction model adopts a pre-trained model based on comparative learning as a basic model, and the score prediction model adopts a regression model as a basic model.

18. The medium of claim 17, wherein instructions causing the device to determine the music evaluation model comprise instructions causing the device to:
determine a sample score based on the target interaction data of the sample music, and construct a music score dataset based on the sample music and the sample score of the sample music; and
use the audio data of the sample music in the music score dataset as input data and the sample score of the sample music as a label to train the basic evaluation model to obtain the music evaluation model.

19. The medium of claim 18, wherein there are a plurality of sample music, and instructions causing the device to determine a sample score based on target interaction data of the sample music comprise instructions causing the device to:
determine a corresponding preference mark probability based on target interaction data of each sample music;
delete sample music with a preference mark probability lower than a probability threshold from the plurality of sample music; and
perform linear transformation and discrete mapping on the preference mark probabilities of the deleted plurality of sample music to obtain a sample score corresponding to each sample music.

20. The medium of claim 19, wherein the target interaction data comprises a playback amount and a preference mark amount, and instructions causing the device to determine the corresponding preference mark probability based on the target interaction data of each sample music comprise instructions causing the device to:
determine a ratio of the preference mark amount to the playback amount of each sample music as a sample passing ratio in estimating a binomial distribution ratio;
use a score interval algorithm to determine a lower bound value of a confidence interval of a corresponding binomial distribution ratio based on a preference mark amount, a playback amount and a sample passing ratio of each sample music and a pre-set confidence level, and determine the lower bound value of the confidence interval as a preference mark probability of each sample music.
